(19) United States
(12) Patent Application Publication
(10) Pub. No.: US 2008/0273008 A1
(43) Pub. Date: Nov. 6, 2008

(54) Interactive image game device for exercise and massage

(76) Inventor: Hong Chang, Taipei City (TW)

Correspondence Address: Joe McKinney Muncy, PO Box 1364, Fairfax, VA, 22038-1364, US

(21) Appl. No.: 11/797,177

(22) Filed: May 1, 2007

(51) Int. Cl. G09G 5/00

(52) U.S. Cl. 345/156; 345/184

(57) ABSTRACT

An interactive image game device for exercise and massage couples exercise, massage and game software together to form an interactive exercise and massage device which includes a plurality of sensors controlled by a user's feet or hands and a display unit which displays game pictures to provide interaction so that users can perform exercise, massage and game playing concurrently to enjoy greater pleasure when in use.

### FIELD OF THE INVENTION

The present invention relates to an exercise and massage device and particularly to an interactive image game device that couples an exercise and massage device with a game software.

### BACKGROUND OF THE INVENTION

“Sole massage” is one of ancient self-help health care methods used by people that can be dated back five thousand years when the medical science was still at the infantile stage. It is still quite popular these days even though modern medical science is well developed. Modern sole massage becomes fashionable in Taiwan some twenty years ago. Its popularity has gradually spread worldwide. Many people have enjoyed the benefits and voluntarily promote this simple self-help exercise through word of mouth to other people.

People's foot (including sole and palm) is like a mirror and can reflect corresponding human organs. By massaging and stimulating the reflection zones people's body and organs can become healthier.

To meet user's requirements many sole massage devices have been developed. They include a roller type, a compressions type or a combination thereof. When in use they compress the sole or palm by rolling or striking, and massage and stimulate vital points. However, the conventional massage devices often look plain. The massage action is dull. People often lose interest after using the massage device in a short period of time. As a result many massage devices are end up in storage or discarded.

### SUMMARY OF THE INVENTION

The primary object of the present invention is to provide an interactive image game device for exercise and massage. It includes an exercise and massage device with at least one sensor in contact with user's foot (sole) or hand (palm) to perform measurement and detection. Through a game software resided in a host and a game picture shown on a display unit, users can control the sensor located on the exercise and massage device through foot or hand while playing the game through the display unit to form interactive actions. Therefore exercise and massage and game playing can be combined to become more interesting and appealing.

The invention includes an exercise and massage device which has at least one massage roller equipped with a first sensor and at least one vital point compression button equipped with a second sensor. The sensors can detect user's foot or hand during exercise. A host is provided which includes a game software unit and a signal processing unit. The signal processing unit receives detection signals from the sensors and transmits the signals to the game software unit. A display unit also is provided which receives signals from the game software unit and displays a game picture on the display unit.

The massage roller and vital point compression button have a plurality of bulged spots on the surface to stimulate user's muscles and vital points.

The sensors are mechanical switch elements, photoelectric sensors or magnetic sensors.

The game software unit in the host is an interactive game software designed according to user's requirements.

The sensors are connected to the host through a transmission interface. The host transmits to the display unit through another transmission interface.

The transmission interfaces may be wired transmission or wireless transmission.

The display unit is a TV or a liquid crystal display (LCD). The host is a computer or a host of a TV game player.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the interactive image game device of the invention in an installation condition.

FIG. 2 is a system block diagram of the invention.

### DETAILED DESCRIPTION OF THE PREFERRED EMBODIMENT

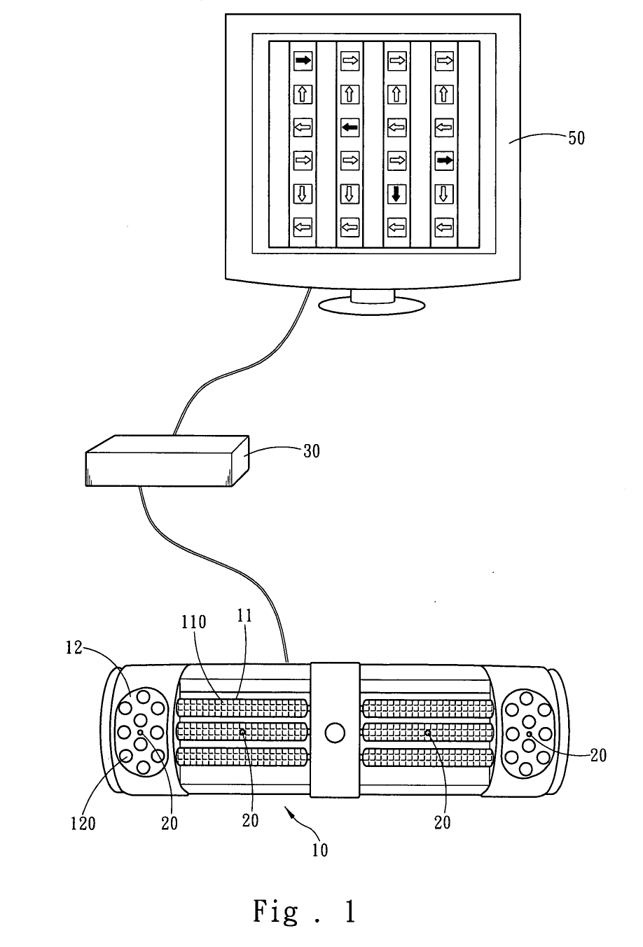

Please refer to FIG. 1, the interactive image game device for exercise and massage according to the invention includes an exercise and massage device 10 which has at least one massage roller 11 and one vital point compression button 12 that have at least one sensor 20 located thereon. The sensor 20 may be a mechanical switch element, photoelectric sensor or magnetic sensor. When a user touches the massage roller 11 or vital point compression button 12 with hands or feet, and the massage roller 11 and the vital point compression button 12 are in operation, the sensors 20 located inside perform measurement and detection. The massage roller 11 and vital point compression button 12 have respectively a plurality of bulged spots 110 and 120 formed on the surface thereof. User's feet or hands can be moved in contact with the bulged spots 110 and 120 to have the sole or palm to be massaged or the vital points to be stimulated.

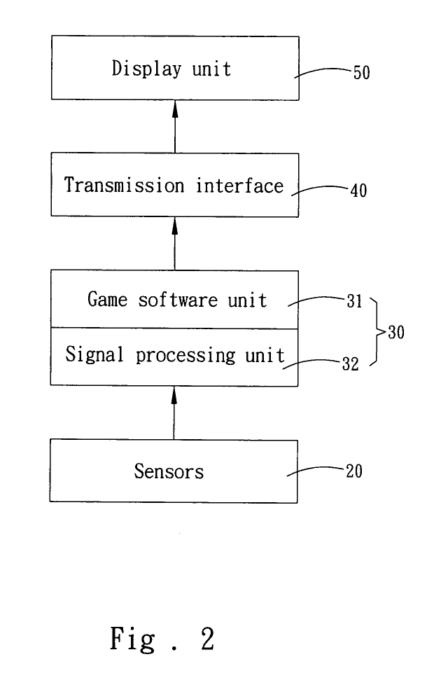

Refer to FIG. 2 for a system block diagram of the invention. When in use user's hands or feet are in contact with the massage roller 11 and vital point compression buttons 12 that have the sensors 20 located thereon. The sensors 20 can detect moving frequency and time of user's hands or feet, and transmit detected signals to a host 30. The host 30 may be a computer or TV game player.

The host 30 has a game software unit 31 and a signal processing unit 32 located inside. The signal processing unit 32 receives the detection signals from the sensors 20. The detection signals are transmitted to the game software unit 31 which transmits the detection signals and game software signals to the display unit 50 through a transmission interface 40 to be displayed in a picture format. The transmission interface 40 may be wired or wireless, such as IR (infrared), RF (radio frequency), Bluetooth, USB, game port, RS232, RS422 or the like. The display unit 50 may be a TV or LCD. In cooperation with the displaying picture users can step or touch the massage roller 11 and vital point compression buttons 12 to perform interaction by controlling the game picture on the display unit 50. For instance, a popular dancing machine now on the market allows a user to step or jump according to the rhythm of a dancing software. A treading mattress is provided with sensors located therein to detect the rhythm of the user to form an interactive movement with the dancing software. The game software unit 31 may contain different game software according to user's requirements.

By means of the construction set forth above, exercise and massage and game software can be coupled to form an interactive exercise and massage device to allow users to control the sensors 20 located on the exercise and massage device 10 with feet or hands while perform interaction movement through the game picture shown on the display unit 50. Thus this invention can combine exercise, massage and game playing together to make using more interesting.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An interactive image game device for exercise and massage, comprising:
an exercise and massage device which has at least one massage roller equipped with a sensor and at least one vital point compression button equipped with another sensor, the sensors detecting movements of a user's feet and hands;
a host which has a game software unit and a signal processing unit which receives detection signals from the sensors and transmits to the game software unit; and
a display unit to receive the signals from the game software unit and display a game picture.

2. The interactive image game device of claim 1, wherein the massage roller has a plurality of bulged spots formed on the surface thereof.

3. The interactive image game device of claim 1, wherein the vital point compression button has a plurality of bulged spots formed on the surface thereof.

4. The interactive image game device of claim J, wherein the sensors are selected from the group consisting of mechanical switch devices, photoelectric sensors and magnetic sensors.

5. The interactive image game device of claim 1, wherein the game software unit contains interactive software games which vary according to user's requirements.

6. The interactive image game device of claim 1, wherein the sensors transmit to the host through a transmission interface.

7. The interactive image game device of claim 1, wherein the host transmits to the display unit through another transmission interface.

8. The interactive image game device of claim 6, wherein the transmission interface is a wired transmission.

9. The interactive image game device of claim 7, wherein the transmission interface is a wired transmission.

10. The interactive image game device of claim 6, wherein the transmission interface is a wireless transmission.

11. The interactive image game device of claim 7, wherein the transmission interface is a wireless transmission.

12. The interactive image game device of claim 1, wherein the display unit is selectively a TV or a liquid crystal display.

13. The interactive image game device of claim 1, wherein the host is selectively a computer or a TV game player.
